(19) United States
(12) Patent Application Publication
(10) Pub. No.: US 2025/0160264 A1
(43) Pub. Date: May 22, 2025

(54) Automatic warehouse for indoor cultivations and relative cultivation method

(71) Applicant: MODULA S.P.A., CASALGRANDE (RE) (IT)

(72) Inventor: Franco STEFANI, SASSUOLO (MO) (IT)

(21) Appl. No.: 18/724,752

(22) PCT Filed: Dec. 21, 2022
(86) PCT No.: PCT/IB2022/062590

§ 371 Date: Jun. 27, 2024

(30) Foreign Application Priority Data
Dec. 27, 2021 (IT) 102021000032678

(51) Int. Cl. A01G 9/029; A01G 9/02; A01G 9/24; B65G 1/04

(52) U.S. Cl. CPC A01G 9/0299; A01G 9/023; A01G 9/247; A01G 9/249; B65G 1/04

(57) ABSTRACT

An automatic warehouse (100) for indoor cultivations is described, comprising: a plurality of drawers (900) individually adapted to carry at least one substrate cultivated with one or more plants, a support structure (105) comprising at least one group of housing seats (125) individually adapted to accommodate one of said drawers (900), at least one delivery station (135) adapted to receive at least one of said drawers (900), a handling device (130) adapted to transfer each drawer (900) from the respective housing seat (125) to the delivery station (135) and vice versa, and an outer casing (145) adapted to enclose the support structure (105) and the handling device (130), said outer casing (145) being provided with at least one window (150) adapted to make the de-livery station (135) accessible from the outside.

### FIELD OF THE ART

The present invention relates to the field of agriculture and concerns, in particular, an automatic warehouse and a method for the cultivation of plant products indoors.

### BACKGROUND

As is well known, agriculture is strongly influenced by the environmental conditions in which plant products are grown.

Some plant products, for example, only grow and develop in certain seasons of the year and/or only in certain climatic zones, where environmental conditions are favourable for their life cycle.

The indoor cultivation technique was introduced in order to be able to cultivate plant products, such as fruit and vegetables, all year round, not just for seasonal harvests, and/or in zones climatically unsuitable for their natural development.

This technique makes it possible to artificially reproduce the most favourable environmental conditions for growing plant products which, otherwise, would not be available in that season or in that particular climatic zone.

Traditionally, indoor cultivations are made in greenhouses where the crops are grown on the ground.

However, this solution has the disadvantage that, in order to achieve high production volumes, a very large surface area of land has to be covered, using correspondingly large and/or numerous greenhouses and, therefore, with costs that are not always acceptable.

In order to reduce the occupied surface area, with the same production volumes, it was proposed to use special warehouses in which the cultivations are arranged on vertical shelvings.

Nevertheless, the use of vertical shelvings introduces non-negligible difficulties and problems linked to the need to allow operators to reach the cultivations.

In fact, current indoor cultivation techniques have a limited degree of automation and most of the cultivation operations, such as irrigation and harvesting, have to be done manually.

### DISCLOSURE OF THE INVENTION

In view of the foregoing, an object of the present invention is to solve or at least significantly reduce the above-mentioned drawbacks of the known technique by making available an automatic warehouse and a method that allow growing high volumes of plant products within relatively small spaces and with a higher degree of automation, thereby also reducing costs.

These and other objects are reached thanks to the characteristics of the invention as set forth in the independent claims. The dependent claims outline preferred and/or particularly advantageous aspects of the invention but not strictly necessary for implementing it.

In particular, an embodiment of the present invention makes available an automatic warehouse for indoor cultivations, comprising:
a plurality of drawers individually adapted to carry at least one substrate (e.g., soil and/or hydroponic inert substrate) cultivated with one or more plants,
a support structure comprising at least one group of housing seats individually adapted to accommodate one of said drawers,
at least one delivery station adapted to receive at least one of said drawers,
a handling device adapted to transfer each drawer from the respective housing seat to the delivery station and vice versa, and
an outer casing adapted to enclose the support structure and the handling device, said outer casing being provided with at least one window adapted to make the delivery station accessible from the outside.

Thanks to this solution, the cultivation of plant products advantageously takes place inside a warehouse in which the most suitable environmental conditions for the development and growth of the relevant plants can be artificially recreated.

Arranging the plants on drawers also allows a more efficient and rational occupation of the inner space of the warehouse, enabling higher production volumes to be achieved. Finally, the handling device that transports the drawers from the housing seats to the delivery station, and vice versa, allows all cultivation operations, such as preparation of the cultivable substrate, sowing and harvesting (as well as any monitoring activities) to be carried out manually and/or in an automated manner in the same place, in a very simple, convenient and safe way.

It is in fact envisaged that the cultivation operations may be carried out manually by operators who act at the delivery station, or by positioning appropriate automated systems at the delivery station (e.g. robots possibly assisted by artificial vision systems) capable of replacing the operators in carrying out the aforesaid operations.

According to one aspect of the invention, the housing seats for the drawers can be mutually superimposed.

In this way, it is advantageously possible to exploit the volume of the warehouse also in height, obtaining a very large cultivated area in relation to the occupied soil.

Another aspect of the invention provides that the outer casing can be insulated.

In this way it is advantageously possible to maintain, inside the warehouse, environmental parameters that are different from those outside, allowing plants to be cultivated in areas and/or climatic periods that are normally unsuitable for their life cycle and also guaranteeing a high standard of quality for the product grown.

In this regard, an aspect of the invention provides that the automatic warehouse can comprise an air handling unit adapted to condition the air inside the outer casing.

Thanks to this solution, it is advantageously possible to ensure that a predefined temperature and/or humidity and/or composition of the air is present inside the warehouse. In particular, the composition of the air can be set by blowing in special gases that promote the growth of the cultivations.

According to one aspect of the invention, the temperature and/or humidity and/or composition of the air can be changed over time.

In this way it is possible, for example, to simulate the natural day and night cycle, typically switching from mild temperatures with limited humidity during the day cycle, to lower temperatures with high humidity levels during the night cycle.

The natural cycle of the seasons or other climatic events can also be simulated in a completely analogous way.

For this purpose, one or more environmental sensors can be placed inside the outer casing, for example chosen from temperature, humidity and air composition sensors.

These sensors can be connected to an electronic control unit, e.g. a PLC, configured to control the operation of the air handling unit based on the measurements made by the sensors, e.g. so that the value measured by each sensor corresponds to a predefined reference value of the respective environmental parameter.

For the reasons set out above, the electronic control unit can then be programmed (or programmable) to modify the aforesaid reference values over time.

A further aspect of the invention provides that the automatic warehouse can comprise a ventilation system adapted to direct air flows against the plants carried by the drawers in the housing seats.

In this way, it is advantageously possible to ensure that the cultivations are subjected to air flows with a predefined speed and/or direction and/or flow rate, for example, optimal for their development.

This ventilation system, which is preferably associated with the air handling unit, may comprise one or more fans with relative distribution and, if necessary, air intake channellings.

According to one aspect of the invention, the speed and/or the flow rate and/or the direction of the air flows can be changed over time, for example by moving suitable bulkheads within the channellings and/or by changing the speed of the fans.

In this way, air can be blown against the plants in different ways according to the needs.

For this purpose, the ventilation system can comprise one or more flow sensors (e.g. flow rate and/or air speed sensors) that can be placed inside the channellings.

These sensors can be connected to an electronic control unit, e.g. a PLC, configured to control the position of the bulkheads and/or the speed of the fans based on the measurements made by said sensors, for example, so that the value measured by each sensor corresponds to a predefined reference value.

Again, the electronic control unit can also be programmed (or programmable) to change each reference value over time.

According to another aspect of the invention, the automatic warehouse may comprise alighting system adapted to illuminate the plants carried by the drawers in the housing seats.

Thanks to this lighting system it is advantageously possible to simulate solar radiation.

The lighting system may comprise lamps, e.g. horticultural lamps, which are adapted to emit radiations within appropriate wavelength ranges.

At least one of these lamps can be placed above each drawer which is located in a housing seat.

According to one aspect of the invention, the emission frequency and/or intensity of these lamps can be changed over time.

In this way it is possible, for example, to simulate the variation of solar lighting during the day and/or in the different seasons.

For this purpose, the lamps can be connected to an electronic control unit, e.g. a PLC, configured to regulate the emission frequency and/or intensity of the light.

Another aspect of the invention provides that the automatic warehouse may comprise a system for irrigating the cultivated substrates which are carried by the drawers in the housing seats.

In this way it is advantageously possible to maintain an adequate level of humidity in the cultivated substrate, without requiring manual intervention by the operators.

This irrigation system can generally comprise at least one water reservoir, dispensing nozzles and at least one pump adapted to pump water from the reservoir to the dispensing nozzles.

According to one aspect of the invention, the quantity of water delivered by the irrigation system to each cultivated substrate can be changed over time.

In this way it is advantageous to regulate the irrigation according to the needs of the plants.

For this purpose, the irrigation system may comprise sensors, e.g. a plurality of humidity sensors individually adapted to detect the humidity of the cultivated substrate carried by a respective drawer.

The presence of these sensors not only ensures the correct supply of water to the plants, but also allows irrigation only when necessary.

This, together with the fact that a cultivation confined within a suitable containment tank for the cultivated substrate is irrigated, leads to the elimination of water waste and economic savings.

These sensors can be connected to an electronic control unit, such as a PLC, which is configured to control the operation of the pump and/or of the dispensing nozzles based on the humidity value measured by the sensors, for example so that the humidity measured from each sensor corresponds to a predefined reference value.

Again, the electronic control unit can also be programmed (or programmable) to change each reference value over time.

The irrigation system may also comprise flow sensors (e.g. water flow rate) downstream of each pump and/or water level sensors in each reservoir, which may also be connected to the electronic control unit.

For example, the electronic control unit can be configured to generate a warning (e.g. of an acoustic or visual type) when the measurement made by the level sensors drops below a predefined threshold value.

In this way it is advantageously possible, for example, to inform operators in good time that a reservoir is empty or almost empty so that it can be filled.

Going into more detailed aspects, each drawer can support one or more containment tanks for the cultivated substrate.

This aspect of the invention provides a particularly simple and inexpensive solution in order to permit to each drawer to carry a certain number of plants.

The containment tanks can be positioned on the respective drawer at an appropriate distance from the bottom and from the sides, in order to avoid contact of the plants with the parts of the drawer itself.

Preferably, each containment tank may have an elongated shape extending predominantly along a predefined longitudinal direction.

Thanks to this solution, each tank can carry a row of plants in a very orderly and rational manner.

In particular, the containment tanks of each drawer may be arranged parallel to each other and mutually spaced in a direction transverse to the longitudinal direction.

In this way, sufficient space can be left between each row of plants for the plants to grow.

According to a preferred aspect of the invention, each drawer may comprise an inlet for an air flow, a distribution system adapted to distribute said air underneath the containment tanks, and a diffusion system adapted to allow air to escape from the distribution system, flowing from the bottom upwards to lap the plants.

Thanks to this solution, each drawer can become an integral part of the ventilation system outlined above, allowing the cultivations to be subjected to optimal air flows for their development.

In particular, air flows moving from the bottom upwards allow the plants located in the containment tanks to be ventilated more evenly and regularly.

One aspect of the invention provides that the distribution system may comprise one or more distribution ducts extending parallel to the containment tanks and vertically staggered with respect to the latter.

In this way, the air can be distributed more evenly along the extension of the containment tanks.

In this context, the diffusion system may comprise a plurality of orifices formed in the lateral walls of said distribution ducts.

This aspect of the invention provides a particularly simple and effective solution for allowing air to escape.

It should be pointed out here that a drawer provided with an inlet for an air flow, a distribution system for said air and an air diffusion system inside the drawer could also find application in other drawer warehouses, similar to the one subject-matter of the present invention, but used for other purposes, for example for the storage of objects whose conservation makes it advisable to strike them with air flows.

According to another aspect of the invention, each drawer may comprise one or more lamps.

Thanks to this solution, each drawer can become an integral part of the lighting system outlined above, allowing a more complete, rational and efficient exploitation of the space available within the warehouse.

In particular, these lamps can be positioned and fixed underneath the drawer.

In this way, the lamps associated with each drawer effectively illuminate the cultivations carried by the drawer below.

Alternatively, the lamps can be carried above the containment tanks, for example by means of a suitable support frame fixed to the relative drawer.

In this way, each drawer is provided with an autonomous lighting system with respect to the other drawers.

However, it is not excluded that, in other embodiments, the lamps of the lighting system can be installed on suitable frames independent of the drawers.

Each of these independent frames can for example be interposed between two mutually superimposed drawers which are located in the respective housing seats.

Said frame can be stably fixed to the support structure of the warehouse or it can be removable and occupy a housing seat interposed between those housing the drawers.

In the latter case, the possibility that the frame carrying the lamps can be moved from its housing seat as far as the delivery station, e.g. for maintenance and/or replacement of the lamps, is advantageously guaranteed.

Another aspect of the invention provides that each drawer may comprise one or more dispensing nozzles adapted to deliver water into, for example, the respective containment tanks.

In this way, each drawer can become an integral part of the irrigation system outlined above, ensuring a more precise and uniform irrigation of cultivations.

In some embodiments, each drawer can further comprise a reservoir adapted to contain water and a pump adapted to pump the water from the reservoir to the dispensing nozzles.

Thanks to this solution, each drawer is provided with a substantially independent irrigation system, which can be more easily implemented and can be supplied with water when the drawer is brought to the delivery station.

However, it cannot be ruled out that, in other embodiments, the automatic warehouse may comprise a centralised water reservoir and a centralised pump adapted to pump water from the reservoir towards the delivery nozzles of all the drawers in the housing seats.

In this case, the dispensing nozzles can still be installed on board the drawers as mentioned above, or they could be installed on supports that are separate and independent from/of the drawers, e.g. fixed to the support structure of the warehouse.

According to another aspect of the invention, each drawer may further comprise one or more sensors, for example chosen from the group consisting of:
humidity sensors of the cultivated substrate located in the respective containment tanks,
water flow sensors downstream of the pump,
water level sensors in the reservoir,
environmental sensors for measuring temperature and/or humidity and/or composition of the air,
speed and/or air flow rate sensors.

Thanks to this solution it is advantageously possible to monitor precisely and accurately the environmental conditions to which the cultivations are subjected on each drawer and, if necessary, regulate irrigation, lighting and ventilation systems accordingly.

Another aspect of the invention provides that each drawer may comprise a first electrical connector, which is adapted to couple with a second electrical connector associated with the support structure, when said drawer is in the housing seat.

In this way it is advantageously possible to obtain an electrical connection capable of powering the electrical components installed on the drawer, such as the lamps, the irrigation pump and the sensors.

According to another aspect of the invention, the apparatus may comprise an electronic control unit, for example a PLC, configured to diagnose and signal (e.g. by means of audible and/or visual alarms) any faults in the electrical components, for example of one of the lighting lamps, of the irrigation pump and/or one of the sensors.

This aspect of the invention has the advantage of alerting operators to the anomaly, allowing them to carry out the necessary repair, replacement and/or maintenance works.

In the event that a fault has been detected in an electrical component installed on a drawer, the electronic control unit can be configured to command the handling device to bring that drawer to the delivery station.

In this way, operators can intervene directly and intuitively on the drawer where the fault has been detected.

The invention also makes available an indoor cultivation method, which comprises the steps of:
providing the automatic warehouse outlined above, and
loading at least one substrate cultivated with one or more plants on one or more of the drawers of said automatic warehouse.

This embodiment substantially achieves the same advantages as the automatic warehouse described above, in particular that of allowing the cultivation of plant products, such as fruit and vegetables, even in climatic zones unsuitable for that type of product, with a high degree of automation and in relatively small spaces.

All accessory features of the invention outlined with reference to the automatic warehouse are of course also applicable, mutatis mutandis, to the corresponding cultivation method.

In particular, the method may involve imposing predetermined temperature and/or humidity and/or air composition values within the casing.

These values can be changed over time, e.g. to recreate the natural cycle of day and night and/or of the seasons.

The method may also involve directing airflows towards the plants carried by the drawers in the housing seats, possibly regulating their speed and/or flow rate and/or direction, for example as a function of time.

The method may also involve illuminating the plants carried by the drawers to the housing seats with artificial light and possibly regulating the frequency and/or intensity of emission of said light over time, for example to simulate the variability of sunlight during the day and in the different seasons.

Finally, the method may involve irrigating the cultivated substrates carried by the drawers to the housing seats and possibly regulating the amount of water supplied to ensure a predefined humidity value.

### BRIEF DESCRIPTION OF THE DRAWINGS

Further features and advantages of the invention will be more apparent after reading the following description provided by way of a non-limiting example, with the aid of the accompanying drawings.

FIG. 1 is an axonometric view of an automatic warehouse according to an embodiment of the present invention, without the outer casing and some of the inner components, in order to better highlight some peculiar features.

FIG. 2 is a front view of the automatic warehouse in FIG. 1, in which the outer casing is partially visible.

FIG. 3 is the section III-III indicated in FIG. 2.

FIG. 4 is an axonometric view of one of the drawers adapted to be used in the automatic warehouse in FIG. 1.

FIG. 5 is a top plan view of the drawer of FIG. 4, shown on a reduced scale.

FIG. 6 is the bottom plan view of the module in FIG. 5.

FIG. 7 is the section VII-VII of FIG. 6, shown on an enlarged scale.

FIG. 8 is the section VIII-VIII of FIG. 7 shown on a reduced scale.

FIG. 9 is an exploded axonometric elevation view of the drawer of FIG. 4.

### DETAILED DESCRIPTION

The aforesaid figures show an automatic warehouse 100, in this case a vertical automatic warehouse, for the realization of indoor cultivations intended for the production of plant products, such as for example fruit or vegetables.

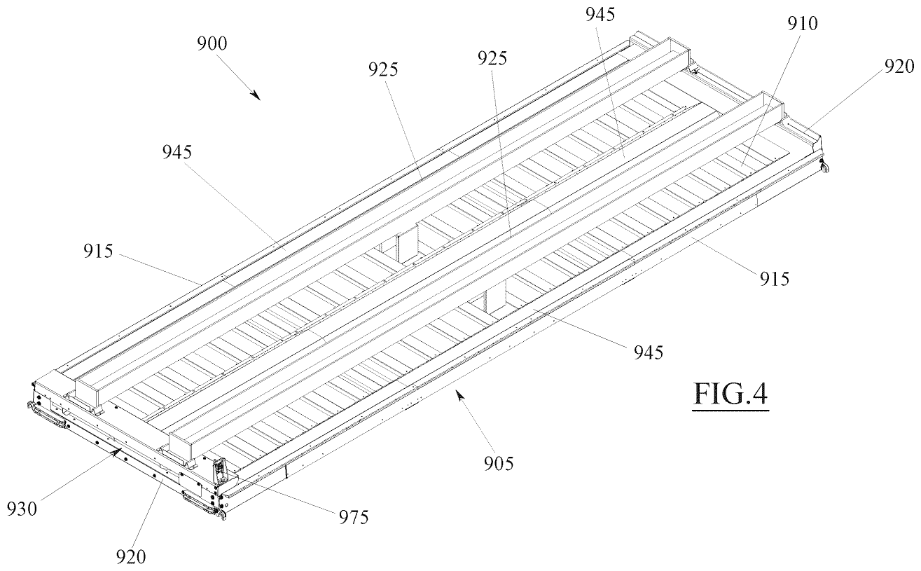

Within the automatic warehouse 100, the cultivations are positioned on board drawers 900 (see FIG. 4), each of which is adapted to carry at least one substrate (not illustrated) cultivated with one or more plants.

This cultivated substrate can be a natural soil and/or an artificial substrate that is otherwise suitable for plant development, e.g. a hydroponic substrate.

Each drawer 900 may globally have a planar shape with a substantially rectangular plan delimited by two pairs of mutually parallel and opposite flanks, of which one pair of longitudinal flanks and one pair of lateral flanks, orthogonal and alternating with the longitudinal flanks.

The longitudinal flanks can have a greater extension than the lateral flanks.

The drawers 900 are preferably all the same, but it is not excluded that, in other embodiments, some of them may have different shapes and/or sizes.

Going into more detail, each drawer 900 can comprise a tray-like body 905 provided with a bottom wall 910, horizontal and with a substantially rectangular plan, from whose longer sides two vertical walls 915 derive which define the longitudinal flanks of the drawer 900.

Each drawer 900 may further comprise two lateral sidewalls 920, which are fixed to the tray 905 at the shorter sides of the bottom wall 910, defining the lateral flanks of the drawer 900 and delimiting, together with the vertical walls 915, the inner cavity of the tray 905.

Each drawer 900 can carry two containment tanks 925 for the cultivated substrate.

Each of these containment trays 925 may have an elongated shape extending predominantly along a predefined longitudinal direction, for example parallel to the bottom wall 910 and to the vertical walls 915 of the tray 905.

The containment tanks 925 of each drawer 900 may therefore be parallel and side-by-side with each other and mutually spaced in the transverse direction with respect to their prevailing dimension.

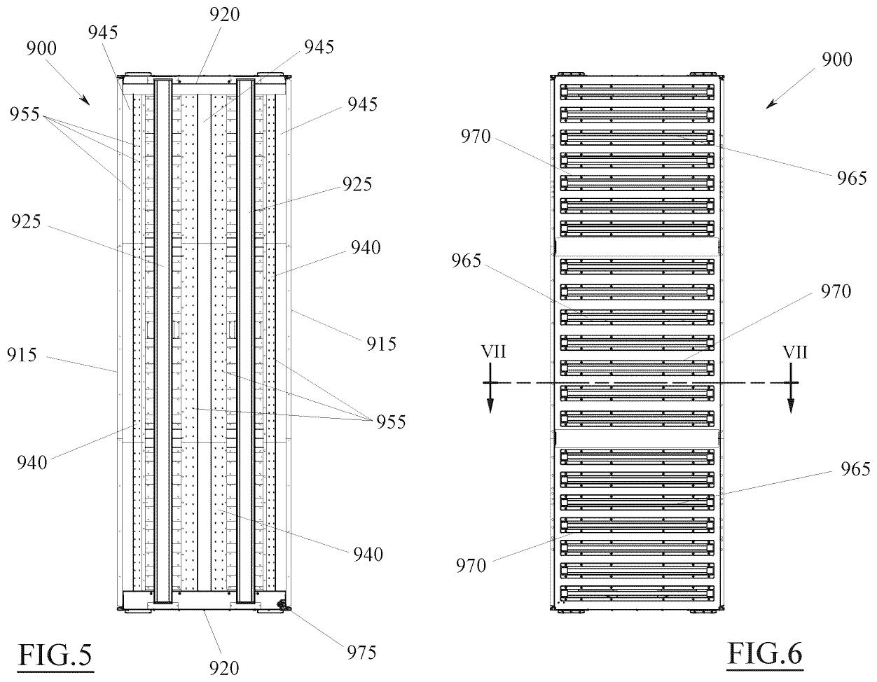

With respect to this transverse direction, each containment tank 925 may also be spaced from the vertical walls 915 of the tray 905 (see also FIG. 5).

In this way, the inner cavity of the tray 905 is open at the top at three empty spaces, of which one empty space is included between the two containment tanks 925, and two further empty spaces which are individually included between each containment tank 925 and the vertical wall 915 adjacent thereto.

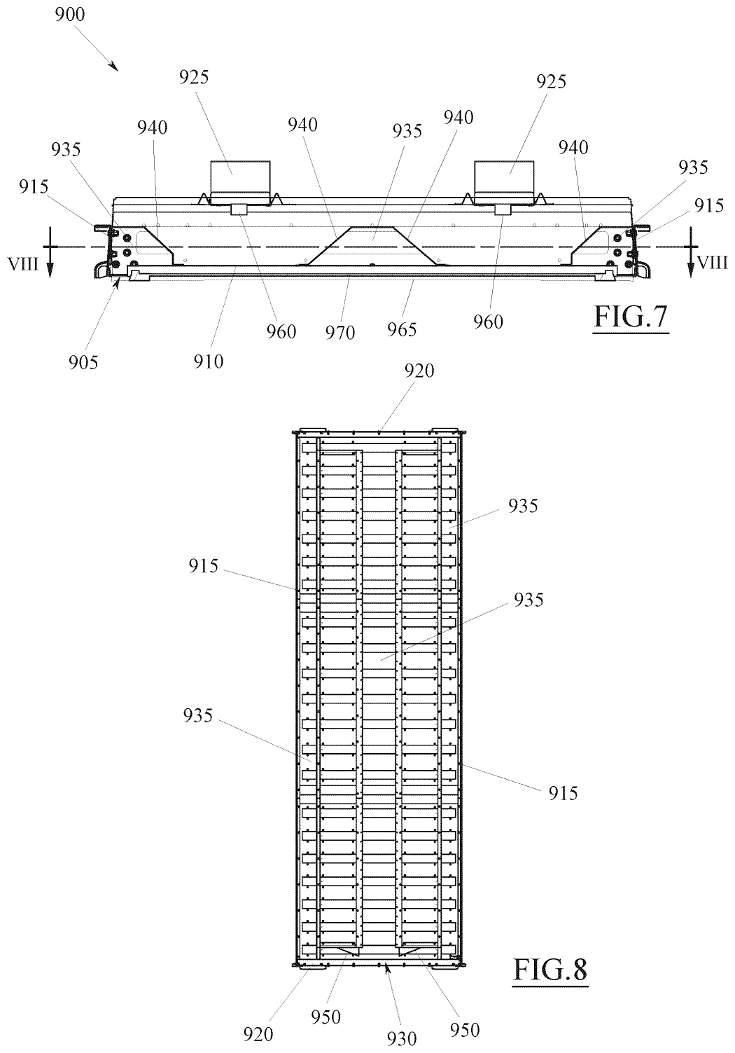

As can be seen in FIG. 7, the containment tanks 925 can also be individually spaced from the bottom wall 910 of the tray 905, from which they are preferably separated by the same distance.

In particular, each containment tank 925 may be carried above the tray 905, preferably with the opposite ends fixed in support on the sidewalls 920.

Although in the illustrated example each drawer 900 comprises two containment tanks 925, it is not excluded that, in other embodiments, it may comprise only one or more than two of them.

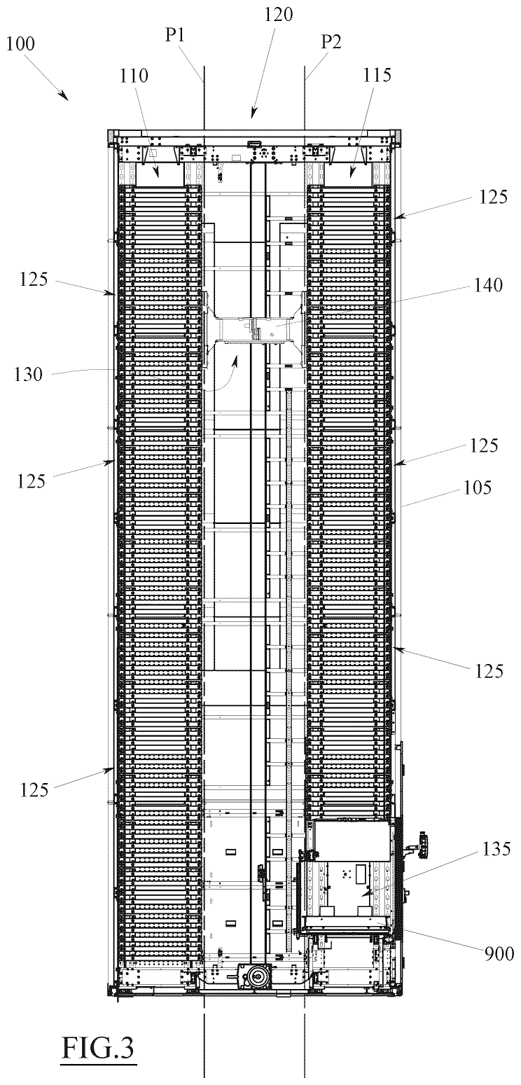

With particular reference to FIG. 3, the drawers 900 are globally contained within a support structure 105 of the automatic warehouse 100, which may generally have the shape of a parallelepiped.

The inner space of the structure 105 may be ideally subdivided in three distinct volumes, of which a first storage volume 110, a second storage volume 115, and an operating volume 120 interposed between the first and the second storage volume 110 and 115.

In other cases, the automatic warehouse 100 could however comprise only one storage volume, for instance only the first storage volume 110 or only the second storage volume 115.

The first storage volume 110 is ideally separated from the operating volume 120 by a first separating plane P1 (imaginary) that is vertically oriented, while the second storage volume 115 is ideally separated from the operating volume 120 by a second separating plane P2 (imaginary) that is parallel to the first separating plane P1.

Actually, at these separating planes P1 and P2, the first and the second storage volume 110 and 115 are open and in communication with the operating volume 120, so as to allow the passage of the drawers 900 as will be clear hereinafter.

The first storage volume 110 may have the shape of a parallelepiped provided with an inner face, parallel or possibly coincident with the first separating plane P1, an outer face, opposite and parallel to the inner face, and two lateral faces, orthogonal to the inner face and mutually opposite.

Similarly, the second storage volume 115 may have the shape of a parallelepiped provided with an inner face, parallel or possibly coincident with the second separating plane P2, an outer face, opposite and parallel to the inner face, and two lateral faces, orthogonal to the inner face and mutually opposite.

As anticipated, the inner faces of the first and second storage volume 110 and 115 are open towards the operating volume 120, while the outer faces and lateral faces may be delimited by corresponding walls of the support structure 105.

The first and second storage volumes 110 and 115 are individually adapted to accommodate a plurality of drawers 900 mutually superimposed on each other in a vertical direction, so as to form a stack.

In the first and second storage volume 110 and 115, each drawer 900 may be horizontally oriented with its own longitudinal flanks parallel to the inner face and the lateral flanks parallel to the lateral faces.

In particular, each drawer 900 can be accommodated in a respective housing seat 125. In other words, the first and the second storage volume 110 may respectively comprise a first and second group of housing seats 125, wherein the housing seats 125 of each group are preferably superimposed on each other and wherein each housing seat 125 is adapted to accommodate a drawer 900.

Each housing seat 125 may comprise, for example, a pair of shelves which, being firmly fixed to the walls of the support structure 105 defining the opposing lateral faces of the first or respectively the second storage volume 110 or 115, are adapted to support the lateral flanks of the drawer 900.

In the enclosed drawings, the housing seats 125 are empty in order not to compromise the intelligibility of the drawings themselves and because the positioning of the drawers 900 in these seats is substantially similar to what occurs in conventional vertical drawer warehouses.

The operating volume 120 may also have approximately the shape of a parallelepiped provided with a rear face, parallel or possibly coincident with the first separating plane P1, a front face, substantially coincident with the second separating plane P2, and two lateral faces, orthogonal both to the front face and to the rear face, and vertical, parallel and mutually opposite.

The front and rear faces are respectively open towards the second storage volume 115 and towards the first storage volume 110, while the lateral faces may be delimited by corresponding walls of the outer structure 105.

Preferably, the lateral faces of the operating volume 120 are parallel to the lateral faces of the first and second storage volume 110 and 115.

Inside the operating volume 120 there is accommodated an automated handling device 130 (visible only in FIG. 3), which is generally adapted to pick up one drawer 900 at a time from the first or second storage volume 110 or 115 and to transfer it to a delivery station 135, where said drawer 900 is accessible to the operators.

In this way, operators can manually carry out all cultivation operations, such as preparing the cultivated substrate, sowing, harvesting or other, while standing still in the same place, in a very simple, comfortable and safe way.

However, it is not excluded that, in other, more advanced embodiments, operators may be replaced by appropriate automated systems (e.g. robots, possibly assisted by artificial vision systems) which, positioned at the delivery point 135, are adapted to perform one or more of the above-mentioned cultivation operations in an automated manner. Naturally, the handling device 130 is also adapted to pick up the drawer 900 from the delivery station 135 and take it back to the first or second storage volume 110 or 115.

The delivery station 135 may be defined by a suitable compartment, which may be for instance vertically aligned with the second storage volume 115.

This compartment may be positioned at the foot of the automatic warehouse 100 or at any other height.

Returning to the handling device 130, it may comprise, for example, a platform 140, which is horizontally oriented within the operating volume 120, where it may make available a loading surface that is also horizontal to support the drawer 900. This platform 140 may be associated with an elevation system which is adapted to move it vertically within the operating volume 120, so as to move it between the height of the delivery station 135 and any height where the housing seats 125 are present.

This elevation system generally comprises guide members adapted to guide the vertical movement of the platform 140 and driving members adapted to drive such movements. The guide members can comprise, for example, rails, vertically oriented and fixed at the walls of the support structure 105, for example those next to the lateral faces of the operating volume 120, as well as the corresponding sliding blocks (typically provided with wheels), which are fixed to the platform 140 and are slidingly coupled with said rails.

The driving members may comprise one or more motors, such as electric motors, and corresponding transmission systems, such as with belt, adapted to transform the rotation of the motors into a suitable translation of the platform 140 in a vertical direction. The transmission systems may also be positioned at the walls of the support structure 105 defining the lateral faces of the operating volume 120.

In any case, the elevation system of the platform 140 is neither illustrated nor described in greater detail, since it is similar to those conventionally used in vertical drawer warehouses.

Suitable gripping and release members are further installed on the platform 140, which, when the platform 140 is stationary at a certain height in the operating volume 120, are generally adapted to hook a drawer 900 which is located in a housing seat 125 of the first or in the second storage volume 110 or 115, or which is located in the delivery station 135, and to drag it with a horizontal translatory movement on board the platform 140 itself.

The same gripping and release members, which are not represented in the drawings since they are also per se conventional, are naturally also adapted to move the drawer 900 which is located on board the platform 140, with a horizontal translatory motion, towards the inside of a housing seat 125 of the first or second storage volume 110 or 115, or towards the inside of the delivery station 135.

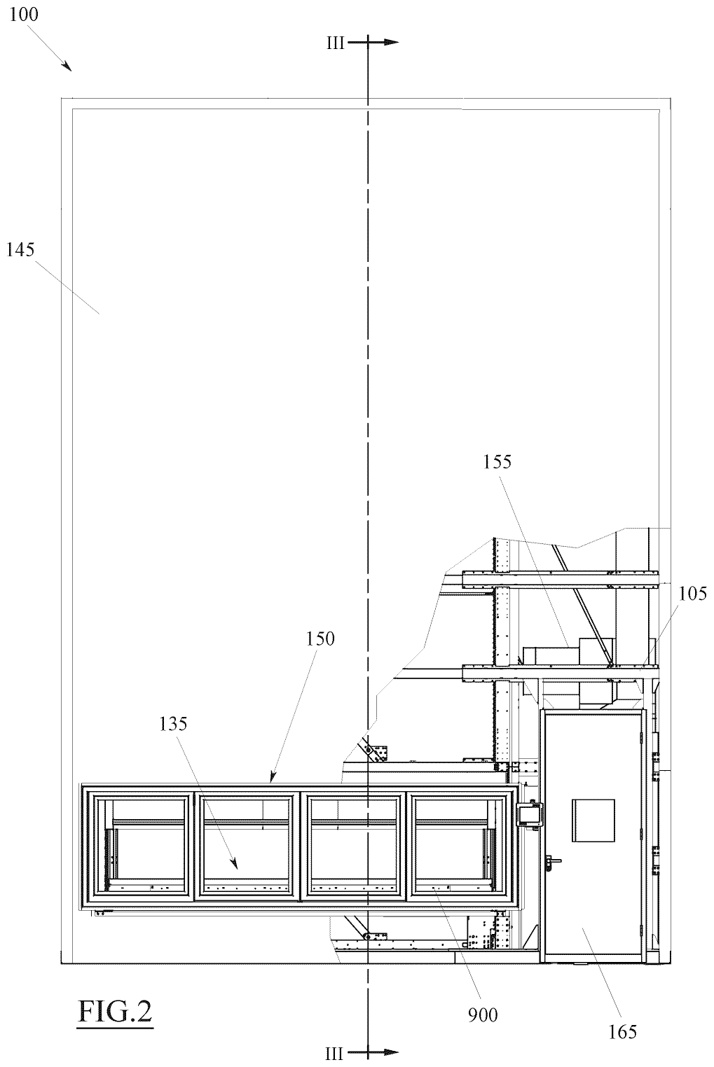

The automatic warehouse 100 may further comprise an outer casing, globally indicated with 145 in FIG. 2, which is adapted to enclose/cover the support structure 105 so that at least the first storage volume 110, the second storage volume 115 (if both are present) and the operating volume 120 (and with it the handling device 130) are enclosed within a closed space.

Of course, at the delivery station 135, the outer casing 145 may comprise a window 150, possibly closable by means of shutters or other openable closure systems, to allow operators to access, from the outside, the drawer 900 possibly located in the delivery station 135.

The outer casing 145 may be made from cladding panels that are fixed directly to the support structure 105 or in any other manner suitable for the purpose.

Preferably, the outer casing 145 is in any case insulated (e.g. thermally insulated) so as to be able to maintain, inside itself (i.e. inside the automatic warehouse 100) environmental parameters (e.g. temperature, humidity, air composition, etc.) that are different from those outside, thus allowing the cultivation of plants in areas and/or climatic periods normally unsuitable for their life cycle and ensuring a high quality standard of the cultivated product.

In this regard, the automatic warehouse 100 can comprise an air handling unit 155 adapted to condition the air inside the outer casing 145, for example in the first storage volume 110, in the second storage volume 115 (if both are present) and in the operating volume 120.

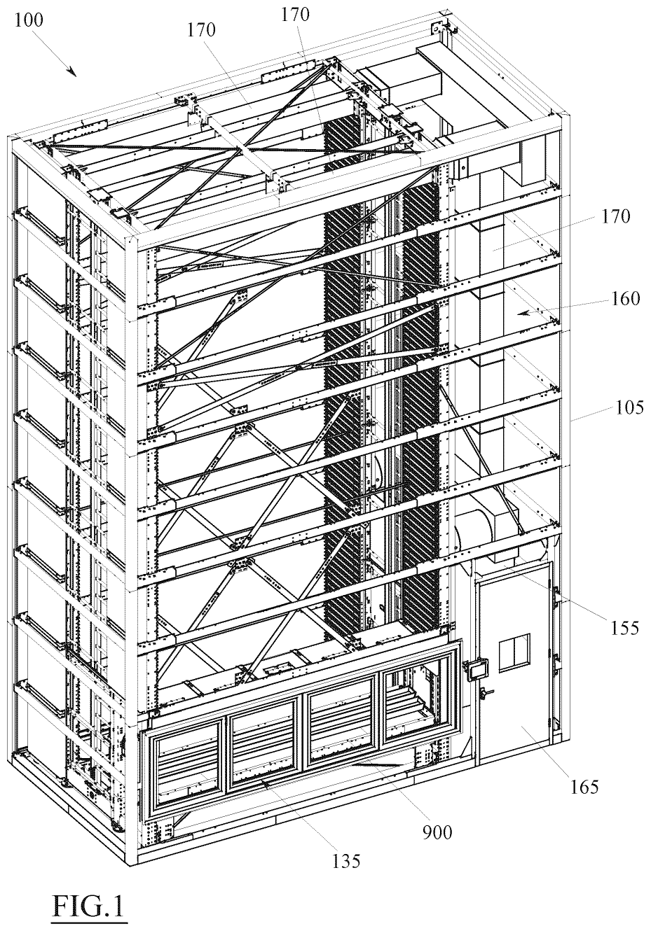

This air handling unit 155 may be accommodated within a service volume 160 (see FIG. 1), or technical compartment, which may also be defined by the support structure 105, may be enclosed by the outer casing 145 and may be accessible through a door 165.

However, it is not excluded that, in other embodiments, the air handling unit 155 may be placed outside the warehouse 100, i.e. outside the outer casing 145, for example for space-saving reasons.

The air handling unit 155 is generally capable of ensuring that the air in the outer casing 145 has a predefined temperature and/or humidity and/or composition.

To this end, the air handling unit 155 may comprise at least one fan capable of drawing in air and pushing it into one or more channellings 170 that are adapted to diffuse it into the volumes enclosed by the outer casing 145.

The air can be drawn in from outside the automatic warehouse 100 and/or at least partially recovered from inside the outer casing 145 through recovery channellings.

The air handling unit 155 further comprises one or more devices adapted to condition the air parameters, including for example the aforesaid temperature and/or humidity and/or composition, after the air has been drawn in but before it is diffused into the volumes enclosed by the outer casing 145.

For example, the air handling unit 155 may comprise one or more heat exchange coils, humidification/dehumidification devices and/or devices to blow in specific gases, typically cultivation growth promoting gases.

All these devices are well known in the air handling industry, so they are not described in more detail.

The temperature and/or humidity and/or composition of the air that is diffused within the outer casing 145 can be changed over time, for example to simulate the natural cycle of day and night and/or the changing seasons.

To this end, the automatic warehouse 100 may comprise one or more environmental sensors, such as temperature sensors and/or humidity sensors and/or air composition sensors, which may be variously located within the outer casing 145.

For example, the environmental sensors may be fixed at various points of the support structure 105 and/or possibly on board the drawers 900 which are located in the housing seats 125.

These environmental sensors can be connected to an electronic control unit (not shown), e.g. a PLC, which can be configured to control the operation of the air handling unit 155.

In particular, the electronic control unit can be configured to modify the operation of the air handling unit 155 on the basis of the values measured by the environmental sensors, for example so that the value measured by each sensor corresponds to a predefined reference value of the respective parameter.

For the reasons explained above, the electronic control unit can also be programmed (or programmable) to change these reference values over time.

In order to ensure an optimal development of certain plant species, it may also be necessary for the plants to be subjected to air flows, e.g. with a predefined speed and/or flow rate and/or direction.

For this reason, the automatic warehouse 100 can comprise a ventilation system capable of directing air flows against the plants carried by the drawers 900 which are located in the housing seats 125.

This ventilation system may comprise the fan of the air handling unit 155 and the channellings 170 associated therewith, so as to obtain a single integrated system that guarantees both the air conditioning of the automatic warehouse 100 and the ventilation of the plants.

In other words, at least a part of the treated air coming from the air handling unit 155 can be diffused in the environment enclosed by the outer casing 145, specifically in the first and/or second storage volume 110 and 115, in the form of air flows that directly strike the plants placed in the drawers 900 located in the housing seats 125.

However, it is not excluded that, in other embodiments, the ventilation system may be separate and independent from/of the air handling unit 155, being for example provided with at least one dedicated fan which, by sucking in air from outside or inside the automatic warehouse 100, pushes it in appropriate channellings towards and against the plants.

In both cases, it is preferable for the ventilation system to be at least partially integrated in the drawers 900.

In other words, each drawer 900 may be provided with means for allowing a flow of ventilation air to lap the containment tanks 925 and, consequently, the plants of the cultivated substrate.

Specifically, each drawer 900 may comprise at least one inlet 930 for air flow (see FIG. 4).

This inlet 930 can be made in the form of an opening formed in one of the two sidewalls 920 delimiting the inner cavity of the tray 905 in a longitudinal direction.

When the drawer 900 is placed in a housing seat 125, the inlet 930 may be in communication with one of the channellings 170 connected with the air handling unit 155, or with any other delivery channelling of the ventilation system.

The inlet 930 may also be in communication with a distribution system installed on board the drawer 900, which is adapted to convey the air flow and distribute it, possibly dividing it into several separate flows, underneath the containment tanks 925.

In the embodiment illustrated, this distribution system comprises one or more distribution channels or ducts 935 (see FIGS. 7 and 8) extending preferably in a direction parallel to the containment tanks 925.

For example, each distribution duct 935 may be made above the bottom wall 910 of the tray 905, within the inner cavity of the latter.

Preferably, the distribution ducts 935 are also staggered with respect to the containment tanks 925 in a vertical direction, i.e., they are positioned such that none of them is completely below, in a vertical direction (i.e., in a direction orthogonal to the bottom wall 910), a containment tank 925.

Thus, for example, in the embodiment illustrated herein, each drawer 900 comprises at least three distribution ducts 935, one of which is located in the space vertically included between the two containment tanks 925, while each of the remaining distribution ducts is located in the space vertically included between a respective containment tank 925 and a respective vertical wall 915 of the tray 905.

Each distribution duct 935 preferably has at least one flat longitudinal flank 940, inclined with respect to the bottom wall 910 of the tray 905 and turned towards the adjacent containment tank 925.

For example, the central distribution duct 935 comprises two flat longitudinal flanks 940, respectively turned towards the one and the other of the containment tanks 925 between which the distribution duct 935 is interposed, while the lateral distribution ducts 935 have only one thereof turned towards the nearest containment tank 925.

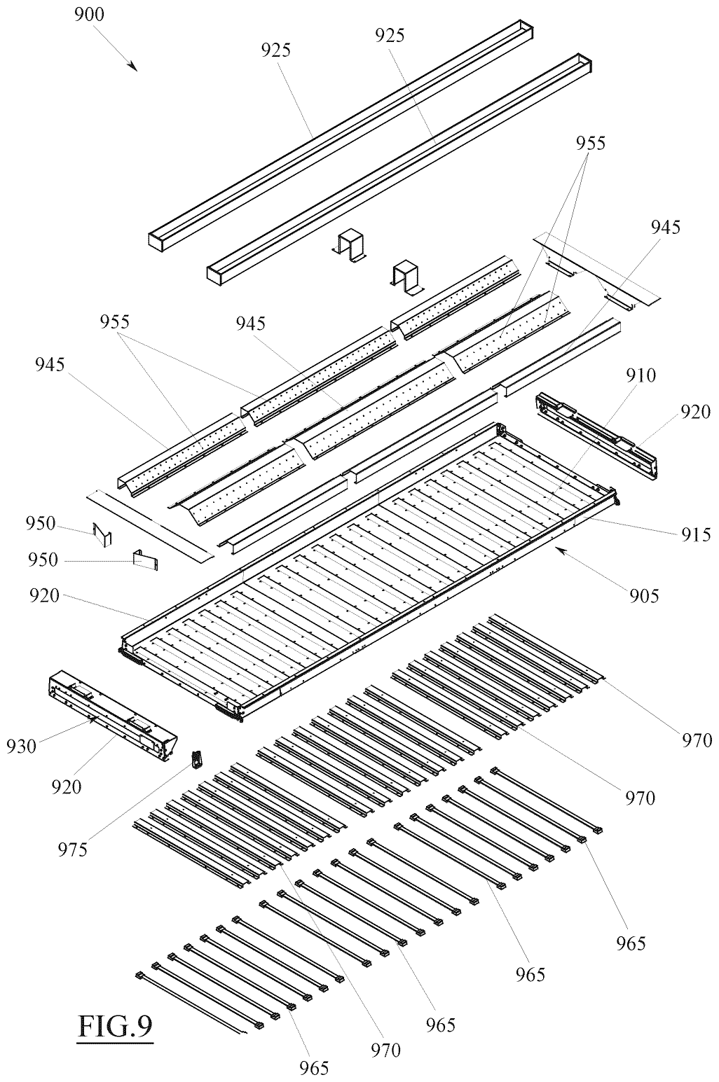

From a constructional point of view, each distribution duct 935 may be formed by one or more channels 945 (see FIG. 9) having a substantially trapezoidal cross-sectional shape and open at the major base, which are fixed to the bottom wall 910 of the tray 905, with their concavity turned downwards, and are mutually aligned with each other, so as to extend globally between the two sidewalls 920.

The channels 945 can be made of folded sheet metal or in any other way.

Each distribution duct 935 may be in communication with the inlet 930 by means of one or more walls 950, also made for example of shaped sheet metal, which guide the incoming air to flow only into the distribution ducts 935 and not out of them.

Each drawer 900 further comprises a diffusion system adapted to allow air to escape from the distribution system, in this case from each distribution duct 935 and, flowing from the bottom upwards, to lap the containment tanks 925 and, consequently, the plants that are grown therein.

This diffusion system may simply comprise a plurality of orifices 955 which are formed on one or more of the lateral walls of each distribution duct 935, preferably at least in the flat longitudinal flank(s) 940 that are turned towards the containment tanks 925, which are thus substantially perforated.

The distribution (along the lateral walls of the distribution ducts 935) and the dimensions of these orifices 955 are preferably chosen in order to ensure a uniform flow of outgoing air.

For example, considering that the inlet 930 can be placed at one end of the distribution ducts 935, in order for the outgoing air flow to be substantially uniform along the entire length of the distribution ducts 935 themselves, the orifices may be progressively more numerous (per unit of wall surface area) and/or larger in size as one moves away from the inlet 930.

In order to ventilate the plants in a different way according to the needs, the speed and/or the flow rate and/or the direction of the air flows striking the plants can be changed over time, for example by modifying the speed of the fans and/or by moving appropriate bulkheads within the channellings 170 and/or within the distribution system present in the drawers 900.

To this end, the ventilation system may comprise one or more flow sensors (e.g. air flow rate and/or speed sensors) which may be placed within the channellings 170 and/or of the distribution system in the drawers 900.

These sensors can be connected to an electronic control unit, e.g. a PLC, configured to control the position of the bulkheads and/or the speed of the fans as a function of the measurements made by said sensors, e.g. so that the value measured by each sensor corresponds to a predefined reference value.

Again, the electronic control unit (which may be the same one that also controls the air handling unit 155) can be programmed (or programmable) to change each reference value of the aforesaid parameters over time.

The automatic warehouse 100 may further comprise a system for irrigating the cultivated substrates carried by the drawers 900 located in the housing seats 125, so as to maintain them at an adequate level of humidity, without requiring manual intervention by operators.

In this regard, each drawer 900 may be provided with one or more dispensing nozzles 960 adapted to deliver water inside the containment tanks 925, so as to irrigate the plants grown therein.

In the example shown, these dispensing nozzles 960 are fitted to the bottom of the containment tanks 925 (see FIG. 7).

However, it cannot be ruled out that, in other embodiments, the dispensing nozzles 960 may be carried, by means of a support frame, above the containment tanks 925, or directly in support and in contact with the cultivated substrate.

By means of a pipe network, the dispensing nozzles 960 (which in some applications could be made in the form of simple orifices obtained in the pipes themselves) can be connected to a water feeding system.

This water feeding system generally comprises a water reservoir and a pump adapted to pump water from the reservoir towards the dispensing nozzles 960.

In some embodiments, the reservoir and the pump may be centralised, i.e. they may be installed within the automatic warehouse 100, for example in the service volume 160, so as to feed all the drawers 900 that are located in the housing seats 125.

In this case, each drawer 900 may comprise a water inlet which, when the drawer 900 is inserted in a housing seat 125, is engaged (releasably) with a channelling connected to the pump delivery.

Alternatively, the dispensing nozzles 960 of each drawer 900, instead of being mounted on board the latter, can be connected with the centralised feeding system and stably fixed to the support structure 105 of the automatic warehouse 110.

In this way, when the drawer 900 is in its housing seat 125, each dispensing nozzle 900 may be positioned above a containment tank 925 and be adapted to deliver water by gravity, possibly after the opening of a valve, directly inside the containment tank 925 and/or in a sort of saucer distributing water along the entire length of the containment tank 925.

Conversely, when the drawer 900 is withdrawn from the housing seat 125, the respective dispensing nozzles 960 (closed by the valve) remain connected to the centralised feeding system and stationary in their position on the support structure 105. In other embodiments, each drawer 900 may nevertheless be provided with a respective reservoir and a respective pump, which may be installed directly on board the drawer 900 itself, for example on the tray 905 and preferably near the axial ends of the containment tanks 925.

In this way, each drawer 900 is autonomously able to provide for the irrigation of the respective cultivations.

In all cases, in order to regulate irrigation according to the needs of the plants, the amount of water delivered by the irrigation system can be changed over time, for example by varying the speed of the pumps and/or by using appropriate valves.

To this end, each drawer 900 can be equipped with one or more sensors.

These sensors may include, for example, one or more humidity sensors adapted to measure the humidity of the cultivated substrate contained in the containment tanks 925.

The presence of these sensors, in addition to ensuring the correct supply of water to the plants, allows irrigation only when necessary, which, together with the fact that a cultivation confined within a suitable containment tank 925 is irrigated, leads to the elimination of water wastage and economic savings.

The sensors can also include a flow sensor (for example of the water flow) located in the pipes downstream of the pump and/or a water level sensor inside the reservoir.

All these sensors can be connected to an electronic control unit, such as a PLC, which can be the same one that also controls the air handling unit 155 and/or the ventilation system.

This electronic control unit can be configured to control the pump and/or the valves of the irrigation system based on the humidity value measured by the humidity sensors, e.g. so that the humidity measured by each sensor corresponds to a predefined reference value.

Similarly, the electronic control unit can be configured to control the pump and/or the valves based on the flow rate value measured by the flow sensors, e.g. so that the flow rate measured by each sensor corresponds to a predefined reference value.

Again, the electronic control unit can also be programmed (or programmable) to change each reference value over time.

The electronic control unit can then be configured to generate a warning (e.g. of an acoustic or visual type), when the values measured by the level sensors drop below a predefined threshold value.

In this way it is advantageously possible, for example, to inform operators in good time that a reservoir is empty or almost empty so that it can be filled.

In particular, when the water level in a reservoir drops below the threshold value, the electronic control unit can directly command the handling device 130, so as to automatically carry the drawer 900 on which that reservoir is installed to the delivery station 135, at which there may be a tap for filling the reservoir itself.

In order to simulate solar irradiation, the automatic warehouse 100 can further comprise a lighting system adapted to illuminate the plants placed in the drawers 900 which are located in the housing seats 125.

This lighting system can comprise lamps 965, e.g. horticultural lamps, which are adapted to emit radiations within appropriate wavelength ranges.

In the embodiment shown in the figures, these lamps 965 are installed on board the drawers 900.

In other words, each drawer 900 may comprise one or more lamps 965 adapted to illuminate the plants within the automatic warehouse 100.

In particular, these lamps 965 can be brought below the drawer 900, for example fixed on the lower side of the bottom wall 910 of the tray 905, preferably by interposing respective lamp holders 970, so as to illuminate the space below.

In this way, the lamps 965 of each drawer 900 are substantially capable of illuminating the plants that are carried by the drawer 900 located immediately below.

Alternatively, the lamps 965 could be carried above the containment trays 925 of the respective drawer 900, for example by means of a suitable support frame fixed to the tray 905.

In this way, the lamps 965 in each drawer 900 would be able to illuminate the plants grown on the same drawer 900, making it independent of all the others.

However, it is not excluded that, in other embodiments, the lamps 965 of the lighting system could be installed on special frames independent of the drawers 900.

Each of these independent frames can for example be interposed between two mutually superimposed drawers 900 which are located in the respective housing seats 125.

Said frame can be stably fixed to the support structure 105 or it can be removable and occupy a housing seat 125 interposed between those housing the two superimposed drawers 900.

In the latter case, the possibility that the frame carrying the lamps can be moved from its housing seat as far as the delivery station, e.g. for maintenance and/or replacement of the lamps, is advantageously guaranteed.

In any case, the frequency and/or intensity of emission of the lamps 965 can be changed over time, for example to simulate the variation of solar illumination during the day and/or in the different seasons.

For this purpose, the lamps 965 can be connected to an electronic control unit, e.g. a PLC, configured to command and control the above parameters.

This electronic control unit may be the same one that also controls the air handling unit 155 and/or the ventilation system and/or the irrigation system.

Finally, the automatic warehouse 100 may comprise an electrical system adapted to power all the electrical/electronic devices and, in particular, those installed on board the drawers 900.

In this regard, each drawer 900 may comprise a first electrical connector 975 which, when said drawer 900 is in the housing seat 125, is adapted to couple with a second electrical connector (not shown) fixed to the support structure 105.

In this way, by simply inserting or removing the drawer 900 into/from the housing seat 125, an electrical connection can be automatically created or released which is capable of powering the electrical components installed on each drawer 900, such as the lamps 965, the irrigation pump and the sensors.

With this same connection or with a similar connection it is also possible to connect the aforesaid electronic components also to the electronic control unit.

In addition to the above, the electronic control unit can be further configured to diagnose and signal (e.g. via audible and/or visual alarms) any faults or anomalies in the electrical/electronic components, e.g. of one of the lighting lamps 965, of the irrigation pump and/or one of the sensors.

In this way, the electronic control unit can warn operators of the anomaly, enabling them to carry out the necessary repair, replacement and/or maintenance works.

In the event that the fault or anomaly has been detected on a component installed on a drawer 900, the electronic control unit can be configured to command the handling device 130 to bring that drawer 900 to the delivery station 135, so as to facilitate immediate action by the operators.

Obviously, a person skilled in the art may make several technical-applicative modifications to all that above, without departing from the scope of the invention as hereinbelow claimed.

1. An automatic warehouse for indoor cultivations, comprising:
a plurality of drawers individually adapted to carry at least one substrate cultivated with one or more plants,
a support structure comprising at least one group of housing seats individually adapted to accommodate one of said drawers,
at least one delivery station adapted to receive at least one of said drawers,
a handling device adapted to transfer each drawer from the respective housing seat to the delivery station and vice versa, and
an outer casing adapted to enclose the support structure (105) and the handling device, said outer casing being provided with at least one window adapted to make the delivery station accessible from the outside.

2. The automatic warehouse according to claim 1, wherein the housing seats for the drawers are mutually superimposed.

3. The automatic warehouse according to claim 1, wherein said outer casing is insulated.

4. The automatic warehouse according to claim 1, comprising an air handling unit adapted to condition the air inside the outer casing.

5. The automatic warehouse according to claim 1, comprising a ventilation system adapted to direct air flows against the plants carried by the drawers in the housing seats.

6. The automatic warehouse according to claim 1, comprising a lighting system adapted to illuminate the plants carried by the drawers in the housing seats.

7. The automatic warehouse according to claim 1, comprising a system for irrigating the cultivated substrates which are carried by the drawers in the housing seats.

8. The automatic warehouse according to claim 1, wherein each drawer supports one or more containment tanks for the cultivated substrate.

9. The automatic warehouse according to claim 8, wherein each containment tank has an elongated shape extending predominantly along a predefined longitudinal direction.

10. The automatic warehouse according to claim 9, wherein the containment tanks of each drawer are arranged parallel to each other and mutually spaced apart in a direction transverse to the longitudinal direction.

11. The automatic warehouse according to claim 8, wherein each drawer comprises an inlet for an air flow, a distribution system adapted to distribute said air underneath the containment tanks and a diffusion system adapted to allow the air to escape from the distribution system, flowing from the bottom upwards to lap the plants.

12. The automatic warehouse according to claim 10, wherein said distribution system comprises one or more distribution ducts extending parallel to the containment tanks and which are vertically staggered with respect to the latter.

13. The automatic warehouse according to claim 12, wherein said diffusion system comprises a plurality of orifices formed in the lateral walls of said distribution ducts.

14. The automatic warehouse according to claim 1, wherein each drawer comprises one or more lamps.

15. The automatic warehouse according to claim 12, wherein said lamps are positioned and fixed below the drawer.

16. The automatic warehouse according to claim 1, wherein each drawer comprises one or more dispensing nozzles adapted to deliver water.

17. The automatic warehouse according to claim 16, wherein each drawer comprises a reservoir adapted to contain water and a pump adapted to pump water from the reservoir to the dispensing nozzles.

18. The automatic warehouse according to claim 1, wherein each drawer comprises one or more sensors.

19. The automatic warehouse according to claim 1, wherein each drawer comprises a first electrical connector, which is adapted to couple with a second electrical connector associated with the support structure, when said drawer is in the housing seat.

20. An indoor cultivation method comprising the steps of:
providing the automatic warehouse according to claim 1,
loading at least one substrate cultivated with one or more plants on one or more of the drawers of said automatic warehouse.

21. A drawer for automatic drawer warehouses comprising:
an inlet for an air flow,
a distribution system for said air, and
a system for diffusing said air inside the drawer.
